(19) United States
(12) Patent Application Publication
(10) Pub. No.: US 2018/0020682 A1
(43) Pub. Date: Jan. 25, 2018

(54) 3-D CUPCAKE DECORATING SYSTEM

(71) Applicant: Ivy L. Bullard, Moriarty, NM (US)

(72) Inventor: Ivy L. Bullard, Moriarty, NM (US)

(21) Appl. No.: 15/653,910

(22) Filed: Jul. 19, 2017

Related U.S. Application Data
(60) Provisional application No. 62/364,223, filed on Jul. 19, 2016.

(51) Int. Cl. A21C 15/00; A47F 7/00; A47J 47/14

(52) U.S. Cl. CPC A21C 15/00; A47J 47/14; A47F 7/0071

(57) ABSTRACT

A three-dimensional cupcake decorating system is described that includes a form mounted to a base that can support the form in an upright position, and also, includes attachment means for securing a plurality of cupcakes about the form in the shape of interest (e.g., animal, article, words). The attachment means can include spikes, collars, cups, double-sided tape, glue dots, bamboo skewers, and toothpicks. The chosen attachment means should successfully secure cupcakes to the form. The attachment means can also be provided in the form of a plurality of spikes mounted to the form in a manner wherein cupcakes can be pushed onto and secured by the spikes against the form. The attachment means can be mounted to the form in a manner whereby the plurality of spikes are slanted upwards so the cupcakes can be pushed onto and more easily secured by the spikes that rest securely against the form.

### INVENTION PRIORITY

The present embodiments claim priority as a continuation application of U.S. Provisional Application Ser. No. 62/364,223, entitled “3-D Cupcake Topiary Decorating System,” which is hereby, incorporated by reference.

### FIELD OF THE EMBODIMENTS

The present embodiments are generally related to systems for and processes of decorating and displaying cupcakes. More particularly, the embodiments related to the provision of a form onto which multiple baked cupcakes can be held in the presentation of a larger three-dimensional item or person, and further onto which the baked cupcakes can be decorated after placement onto the form.

### BACKGROUND

Current products for presenting cupcakes include stands that are made of acrylic, cardboard, glass, plastic, and various other materials. These stands often consist of a flat surface and sometimes include supporting rods or gussets in between.

While cupcakes are a good way to serve individual pieces of cake and are fairly easy to decorate, problems can be encountered when there is a need for a large number of cupcakes in terms of the amount of handling of cupcakes from oven to serving tray, as well as the problem encountered with the amount of table space need to serve many cupcakes. Usually cupcakes are removed from baking tin, put on a rack to cool, decorated, and placed on a serving tray. Sometimes extra steps are involved if the cupcakes need to be transported to a different location. The cupcakes need to be arranged in a carrying container, transported to a venue, removed from a container, and finally arranged on some sort of display tray. Most cupcake holders are round or square trays stacked in layers with some sort of rod separating each layer. These are often made of plastic, acrylic, cardboard, metal, and other such materials. While these trays work well for displaying cupcakes, oftentimes these trays fall, short, in actually holding a large number of cupcakes even though their size would indicate they should. That is because much space is taken up by the rod or supporting device in the center of the holding tray, which separates the layers.

Topiary is a term associated with ornamental gardening. It is the art or practice of clipping shrubs or trees into ornamental shapes, such a three-dimensional animals or musical instruments. The fields of baking and gardening couldn't be further apart; however, because topiary has resulted in very appealing three-dimensional shapes for tress, plants and bushes, it is a field with impressive results and attributes that the present inventor believed could possibly be applied to the field of baking.

What is needed is a system and methods that make it possible to use cupcakes for dessert as well as for use as the decoration by placing cupcakes on a 3-D form for presentation of figures similar to what is possible in the field of topiary, but from which people may pull and eat the decorated cupcakes therefrom.

### SUMMARY OF THE EMBODIMENTS

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is a feature of the present embodiments to provide a three-dimensional (3-D) cupcake decorating system that includes a form mounted to a base that supports the form in an upright position, and also attachment means for securing a plurality of cupcakes about the fore in the three-dimensional shape of interest (e.g., animal, article, words, etc.).

In accordance with another feature of the embodiment, the attachment means can include spikes, collars, cups, double-sided tape, glue dots, bamboo skewers, and toothpicks. The chosen attachment means should successfully secure cupcakes to the form.

In accordance with yet another feature of the embodiments, the attachment means can be provided in the form of a plurality of spikes mounted to the form in a manner wherein cupcakes can be pushed onto and secured by the spikes against the form. The attachment means can be mounted to the form in a manner whereby the plurality of spikes are slanted upwards so the cupcakes can be pushed onto and more easily secured by the upwards-slanted spikes and at rest securely against the form.

It is a feature of the embodiments that the general shape of the form can be selected from and provided in the general shape of at least one of: Dinosaurs, Elephants, Hippos, Mammoths, Zebras, Rhinos, Buffalo, Elk, Deer, Antelope, Turkeys, Ibex, Oryx, Zebras, Stags, Birds, Reptiles, Lions, Tigers, Bears, Ducks, Kangaroos, Cheetahs, Pumas, Jaguars, Giraffes, Monkeys, Gorillas, Orangutans, Horses, Cows, Pigs, Chickens, Peacocks, Grouse, Sloths, Bees, Sheep, Goats, Donkeys, Mules, Horses, Butterflies, Dragonflies, Spiders, Beetles, Ladybugs, Whales, Sharks, Dolphin, Fish, Porpoise, Octopus, Meerkat, Cats, Dogs, Unicorns, Mermaids, Dragons, Rivers, Oceans, Lakes, Guitars, Cellos, Flutes, Violins, Trombones, Drums, Musical Notes, Graduation Hats, Graduation Gowns, Baby Bottles, Baby Shoes, Baby Clothes, Pacifiers, Eiffel Tower, Depiction of Mount Rushmore, Lincoln Memorial, Statue of Liberty, Flags, Numbers, Wedding Dresses, Wedding Veils, Wedding Shoes, Shoes, Purses, High Heels, Low Heels, Women's Clothes, Jewelry, Men's Clothes, Kids Clothes, Hats, Umbrellas, Flowers, Hearts, Human Form, Parts of the Human Form, Animal Skulls, Human Skulls, Chairs, Beds, Windows, Houses, Doors, Planets, Cloud Shapes, Sun, Moon, Stars, Trees, Cars, Trucks, Trains, Covered Wagons, Construction Equipment, Earthmoving Equipment, Airplanes, Shovels, Motorcycles Bikes, Scooters, Carts, Roller Skates, Skateboards, Spades Rakes Buckets, Dishes, Utensils Bee Hives, Nests, Eggs, Faberge Eggs, Coins, Money, Buttons, Zippers, Scissors, Tools, Famous Art, Pies, Cakes, Cupcakes, Fruits, Vegetables, Desserts, Snowmen, Witches, Fairies, Christmas, Ornaments Wreaths, Bells, Whistles, Bags, Flower Pots, Spheres, Cubes, Geometric Shapes, Shapes of Countries, Universal Symbols, Tubs, Boxes, Fans, Stethoscopes, Doctors and Nurses Clothes and Hats, Medical devices, Badges, Gems, Gemstones, Suitcases, Trunks, Boats and Ships, Sea Craft, Lighthouses, Menorahs, Star of David, Crosses, Statues, Kali, Buddha, Gods of all Religions, Jesus, God, Madonna, Clocks, Candles, Books, Bible, Bird Houses, Barns, Churches, Praying Hands, Books, Rosary Beads, Crosses, Religious symbols, Chalices, Electronic Devices, Blocks, Megaphones, Cards, Dice, Board Games, Jacks and Balls, Comets, Wood, Towers, Igloos, Teepees, Christmas Trees, Hearts, Vampires, Werewolves, Tree Houses, Exercise Equipment, Volcanos, Geodes, Mountains, Rocks, Dog Houses, Stuffed Toys, Toys, Bubbles, Balloons, Hot Air Balloons, Blimps, Covered Wagons, Rockets, Submarines, Depictions of cartoons or figures from animated movies, Dolls, Action Figures, Super Heroes, Puppets, Marionettes, and Punctuation Marks.

It is yet another feature of the embodiments that a carrying case can be included with handles and a top, wherein the cover can be attached to the base via a locking mechanism (e.g., latches) and can completely cover and secure the form and cupcakes assembled thereon within the case as supported by the base.

It is yet another feature that filler plugs can be provided that are adapted to accept decorative material in the form of at least one of cake frosting, stickers, candy pieces, coins, flowers, plastic objects, wherein the decorative material is attached to the form to fill spaces between cupcakes held on the form.

### BRIEF DESCRIPTION OF THE DRAWINGS

The accompanying figures, in which like reference numerals refer to identical or functionally-similar elements throughout the separate views and which are Incorporated in and form a part of the specification, further illustrate the embodiments and, together with the detailed description, serve to explain the embodiments disclosed herein.

FIGS. 1A-1C illustrate a form adapted to hold cupcakes in three-dimensional shapes and supported by a base, in accordance with features of the embodiments;

FIGS. 2A-2B illustrate a form adapted to hold cupcakes in three-dimensional shapes, including spikes to attach cupcakes to the form, in accordance with features of the embodiments;

FIG. 3 illustrates a form adapted to hold cupcakes in three-dimensional shapes on spikes attached to the form, further including markings on the form to indicate locations on the form where the cupcakes should be attached, in accordance with the embodiments;

FIGS. 4A-4B illustrate a form adapted with hardware to hold cupcakes in three-dimensional shapes on the form, in accordance with the embodiments;

FIG. 5 illustrates a form adapted with depressions (representing circular cup-like holes) to hold cupcakes in three-dimensional shapes on the form, in accordance with the embodiments;

FIGS. 6A-6C illustrate small cake forms of varying shapes that can be utilized as cake forms (or similar to pans) during baking, can be mounted onto a form in a specified shape, and can be supported by a base, in accordance with the embodiments;

FIG. 7 illustrates filler plugs that can include a head and a spike, with the head having a surface whereon decorative material can be placed, and the plugs can be used to fill gaps between cupcakes, in accordance with the embodiments;

FIG. 8 illustrates a sticker attached to the head of a filler plug, which can then be attached to a form to enhance cupcakes as decorations, in accordance with the embodiments;

FIGS. 9A-9B illustrate hardware that can be utilized to attach a form to a base, in accordance with the embodiments;

FIGS. 10A-10D illustrate features of a cover that can integrate (fasten to) a base to cover and protect cupcake designs affixed to form and supported by the base within the cover, in accordance with the embodiments;

FIG. 11 illustrates a completed 3-D cupcake decoration in the form of a guitar that is protected by a cover attached to the base, in accordance with the embodiments;

FIG. 12 illustrates a three-dimensional design in the form of a guitar with decorative attachments in the form of guitar tuning keys being attached to what is identified has the head of the guitar shape, in accordance with the embodiments;

FIGS. 13-14 are pictures of dinosaur parts that can be attached to a form including cupcakes to provide a three-dimensional design, in accordance with the embodiments; and

FIG. 15 illustrates a diagram wherein cupcakes together with plastics pieces can be utilized together for a design, in accordance with the embodiments.

### DETAILED DESCRIPTION OF THE EMBODIMENTS

The particular values and configurations discussed in these non-limiting examples can be varied and are cited merely to illustrate at least one embodiment and are not intended to limit the scope thereof.

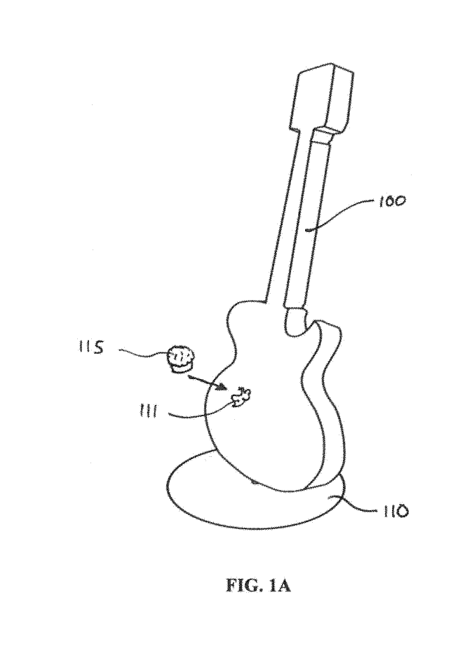

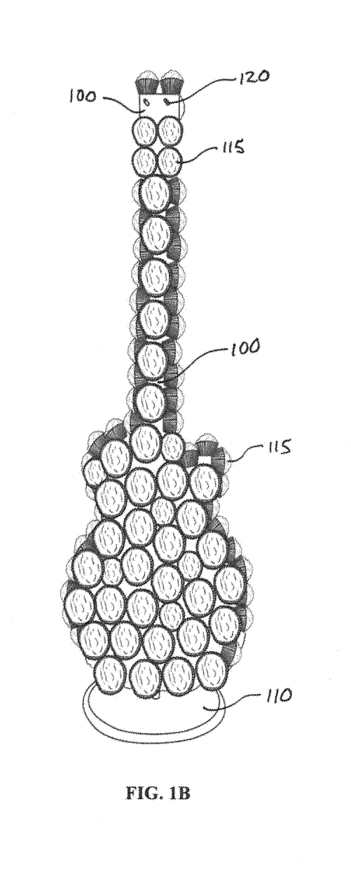

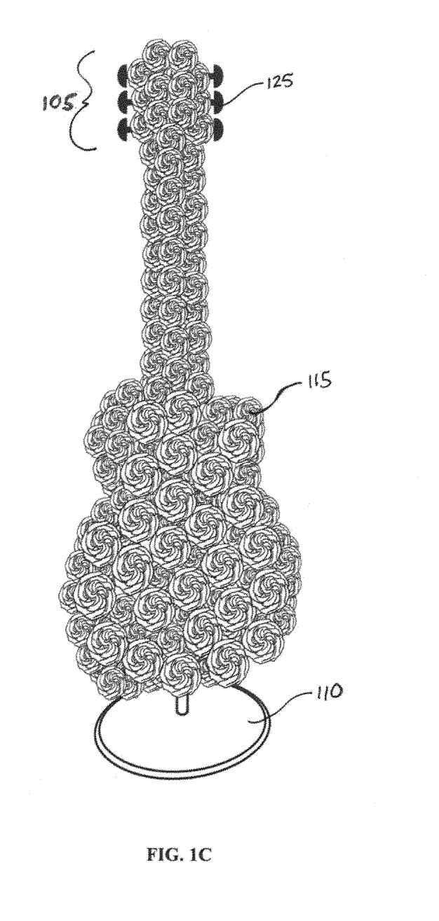

It is a feature of the present embodiments to provide forms in different shapes, such the guitar shaped form 100 illustrated in FIG. 1A, that can hold several cupcakes 115 in the shape of a three-dimensional figure (e.g., musical instrument, animal, person, etc.) and can also be stood upright on and supported by a base 110. Cupcakes can be attached onto these forms by various attachment means 111 (e.g., spikes, holes, collars). The form 100 and attachment means 111 enable an appearance of baked items similar to actual plant topiary once a preferred design is completed, but as a form of topiary that uses cupcakes 115 instead of plants, trees, and bushes to create unique shapes.

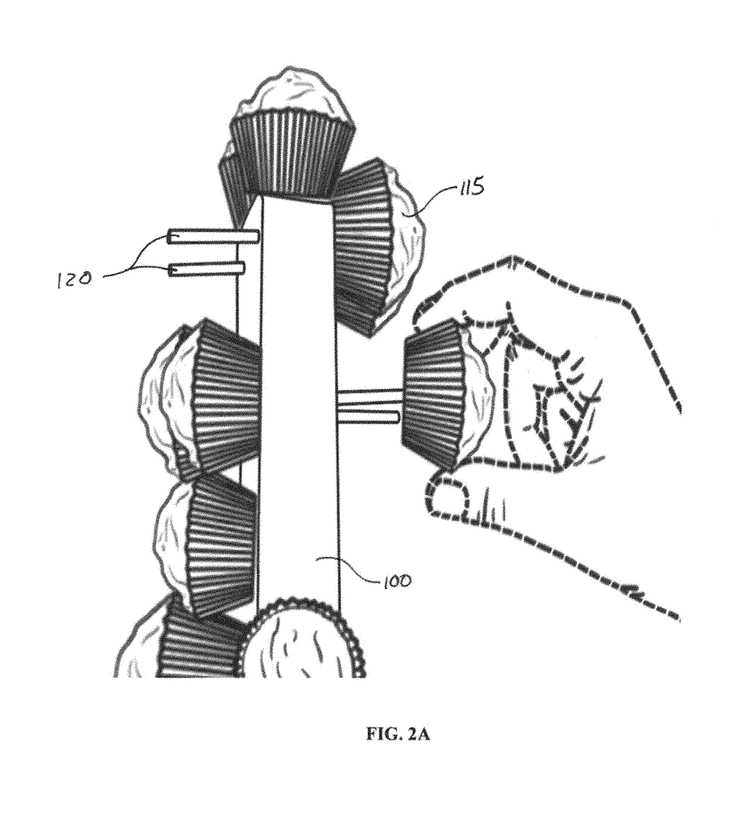

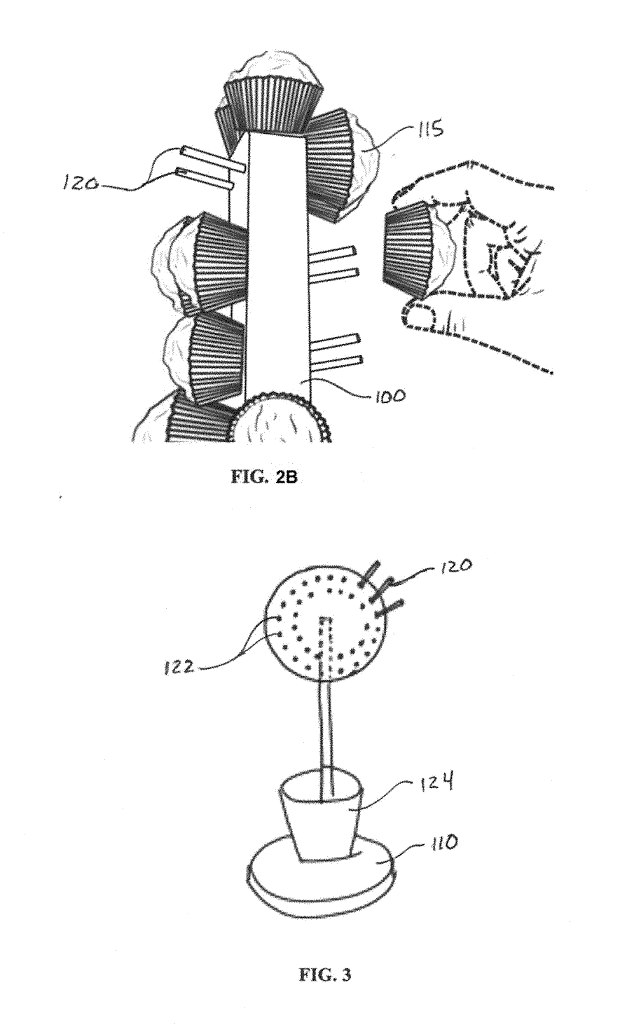

Referring to FIG. 2A, spikes 120 made of wood, plastic, or any other suitable material, which can be pointed or blunt, can be placed at pre-determined intervals along the form 100 so the baker/designer does not have to guess where to place the cupcakes 115 onto the form 100 for the best overall appearance. The form 100 as shown in FIG. 1B is almost completely decorated by the attachment of cupcakes 115 to attachment means 120 deployed throughout the form 100. The form is shown being held upright (supported) on top of a base 110 that it can be attached to. Referring to FIG. 1C, a completed design of the form 100 in the shape of a guitar is illustrated with finishing hardware touches 125 depicting guitar threats being installed on the area of the form 100 that is known to be the head portion of a guitar.

Referring to FIG. 2A, attachment means in the form of spikes 120 is further illustrated. The spikes 120 can be installed, coupled, mounted, secured, to the form 100 in a manner that cupcakes 115 can be pushed onto and secured by the spikes 120. FIG. 2A illustrated several cupcakes 115 being held against the form 100 by spikes 120 and illustrates a baker installing a cupcake onto a spike during construction of a design. Referring to FIG. 2B, attachment means in the form of spikes 120 can also be installed, coupled, mounted, secured, to the form 100 in a manner whereby the spikes 120 are slanting upwards so the cupcakes 115 can be attached to the upwards-slanted spikes without concern that the cupcakes 115 will slip off of the spikes 120. In this manner, the spikes operated more as a hook, utilizing gravity to better secure cupcakes 115 against the form 100 and on the spikes 120. It is also an option that no spikes 120 can be pre-placed on the form 100 at all, but instead the baker can be able to add cupcakes 115 by self-placing wood spikes 120 onto the form 100. Placement of spikes during the design and decorating process can be possible by use of strong double-sided tape, glue dots, bamboo skewers, toothpicks, or any other type of affixing system known in the art today.

As with real plant topiary, the themes or shapes that could be used for cupcake decorating in accordance with the practice of embodiments described herein are almost endless. The 3-D forms 100 can be made in different sizes to accommodate large or small table space, size of decorating site, or number of servings needed. The 3-D forms 100 can be formed in one piece or in two halves that are attached with double-sided tape, glue dots, or any other affixing material known in the art today. The 3-D forms 100 onto which cupcakes 115 are affixed can be made of foam, self-healing foam, polystyrene, acrylic, plastic, nylon, pvc, hdpe, metal wire, mesh, paper Mache, or any other suitable material known in the art today. For example, materials such as wire mesh and foam could be used in combination to make the forms. It may be preferable for food grade materials to be used.

Referring to FIG. 3, printed dots 122, or other markings, can be placed on the form 100 to indicate locations where the cupcakes 115 should be attached. Depending on the type of form, the baker may attach the cupcakes 115 with spikes 120, which can be provided in the form of wood pegs, plastic pegs, toothpicks, bamboo sticks, glue dots, hook and loop dots or squares, any other affixing method known in the art today. The form 100 shown in FIG. 3 is in the exemplary shape of a potted plant or flower with a pot 124 that can be supported by a base 110.

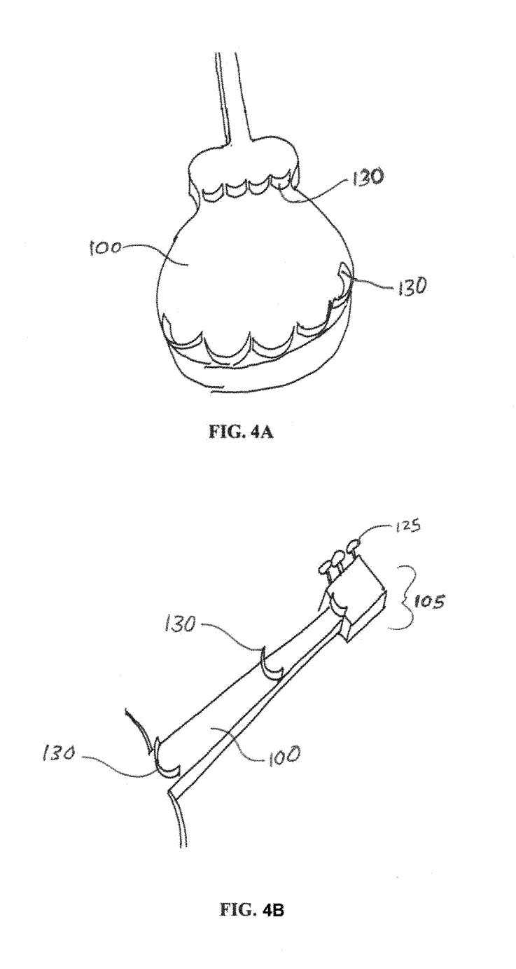

In another embodiment illustrated in FIGS. 4A-4B, collars 130 can be embedded at various locations on the form 100 to hold the first row of cupcakes 115 or they may be added every few layers so the cupcakes 115 on top of the design do, not exert too much pressure on the bottom row or lower levels of cupcakes 115. Collars 130 may be added all over the form 100 in case the manufacturer finds this a more efficient way to hold cupcakes 115.

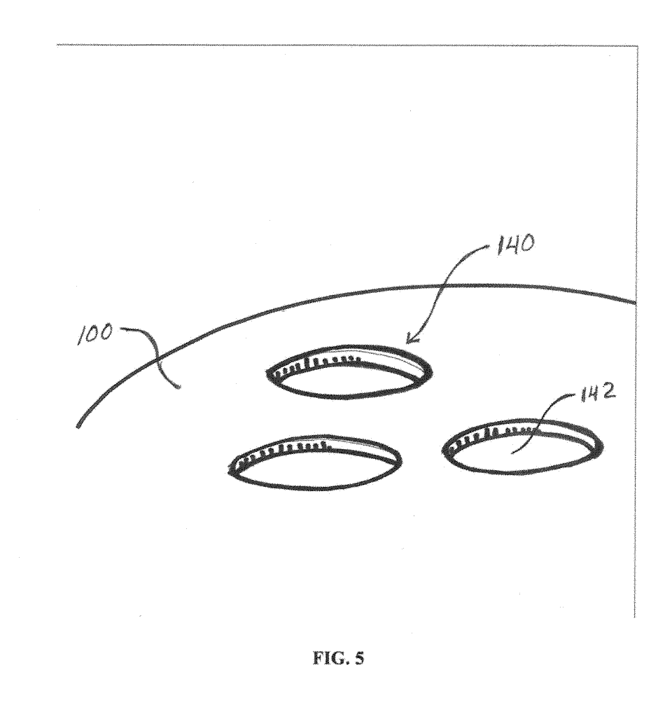

In yet another embodiment, as shown in FIG. 5, depressions 140 representing circular cups can be provided within a form 100 in sizes to hold either a mini or a standard size cupcake 142. The cups 140 when used in the form 100 serve a purpose of holding the cupcakes in place on the form 100, just as the spikes 120 and collars 130 serve this same purpose. The form 100 wherein the cups 140 are formed can be made of foam, self-healing foam, acrylic, plastic, nylon, pvc, metal wire, mesh, paper Mache, or any other suitable material known in the art today. The holes are of a smaller diameter than the top diameter of the cupcakes so that the cupcakes rest in the holes. A spike 120 similar to what has been described herein before can be added within the center, bottom of the cup formed within the form 100 for extra hold of cupcakes 115.

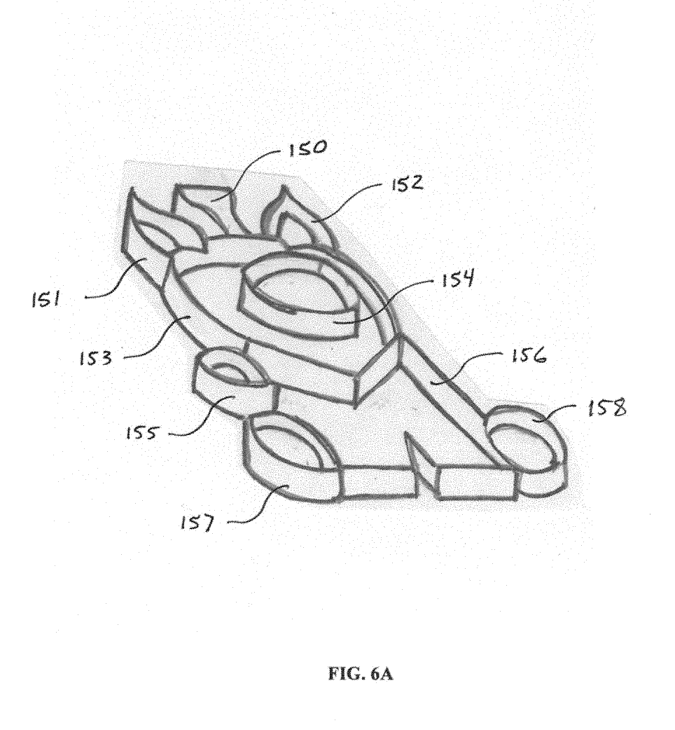

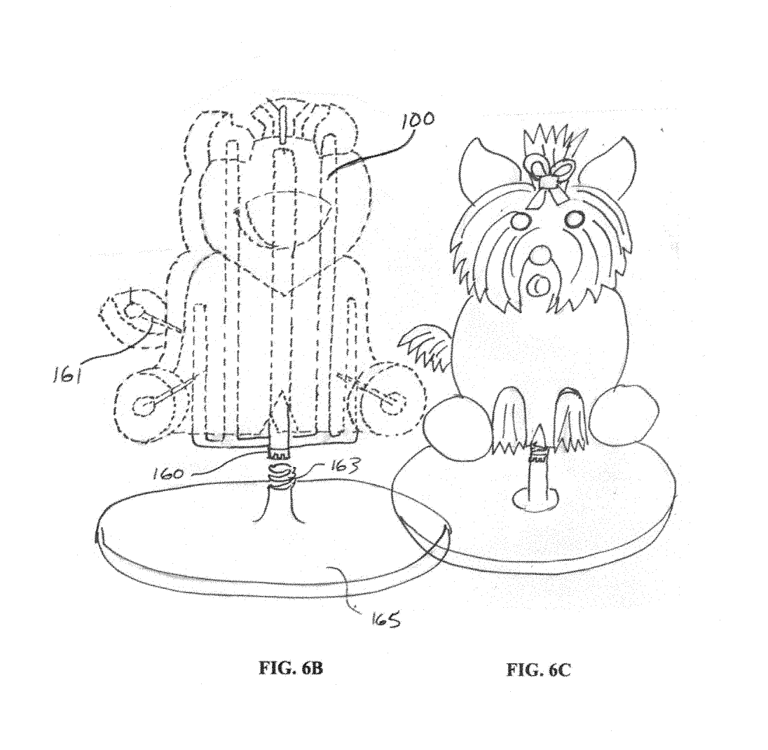

In yet another embodiment, as shown in FIG. 6A, special small cake forms 150-158 of varying shapes can be utilized as cake forms (or similar to pans) during baking. They can be made of cardboard suitable for the oven, metal, silicon, or other material known in the art today. These small cake forms 150-158 when filled with batter, and baked, can create “puzzle” pieces of cupcakes or cakes of varying shapes that are designed to be assembled in a pattern together as shown in FIGS. 6B-6C and fit on the form 100. After the small cake forms 150-158 are attached to the frame of main form 100, the whole design can be frosted to complete the design. Prior to attachment of the cake forms 150-158, the form 100 can be attached by a female connector 160 to a male connector 163 of a base 165, as shown. The thickness of the pans can vary but can be thick enough to accommodate, or attach to, a form 100 underneath. When the cupcakes or cake pieces represented are removed from an oven are then put together on the 3-D form or a frame so that all spaces between the cupcakes are accounted for, thus giving the appearance of a 3-D cake. The cake pans can also be shaped like actual puzzle pieces and embedded on the frame 100 to create various designs. This can add a fun element to decorating, especially for kids who, usually enjoy putting together puzzles. As shown in FIG. 6B, a filler plug 161 can be used to fill-in spaced between round cupcakes 115 or small cake forms 150-158.

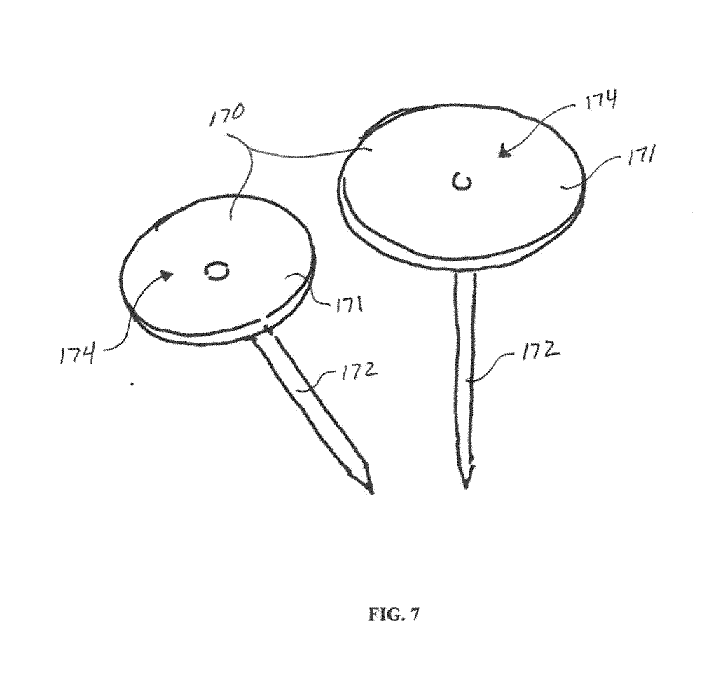

Referring more particularly to FIG. 7, a filler plug 170 is shown that an include a head 171 and a spike 172 (similar to a nail with a flat disc head, a “cake nail”), with the head having a surface 174 whereon decorative material (e.g., frostings, stickers, etc.) can be placed. Alternatively, the head 171 can include, or be replaced, by a cup that can receive decorative material. The filler plug 170 can be made of plastic, wood, cardboard, candy, foam, metal, or any other suitable material known in the art today and can be used to fill in the gaps between cupcakes.

As discussed above, filler plugs 161/170 can be frosted over or various “decorations” such as stickers, plastic or candy gems, pieces of hard candy, coins, flowers, or any other objects used in the art today, and which may be added to the overall design. These decorative materials can employ glue dots, tape, hook and loop dots, or any other affixing method known in the art today or the decorations themselves may have a sticky back that can attach to the nail face.

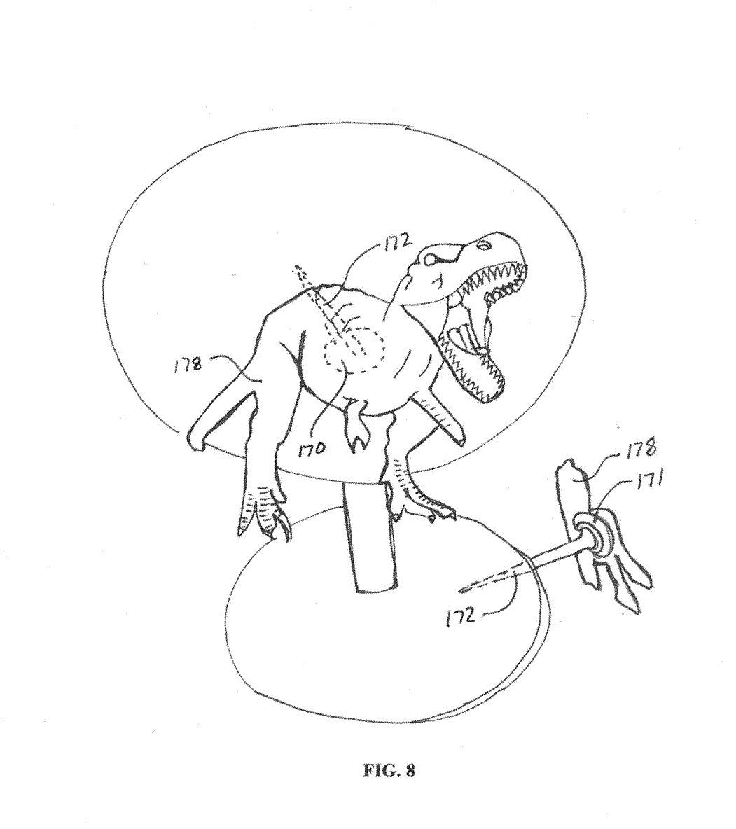

Referring to FIG. 8, a sticker 178 is shown attached to the head 171 of a filler plug 170 (shown within a blown up window). Then the filler plug 170 is shown inserted into a base 100 by the spike 172. A baker or cake designer can choose not to use the nail spikes or decorations, so small spaces in between cupcakes can be filled in with pieces of cupcake and frosting for an even and uniform appearance, but filler plugs clearly offer a decorating advantage for use of the presently described system.

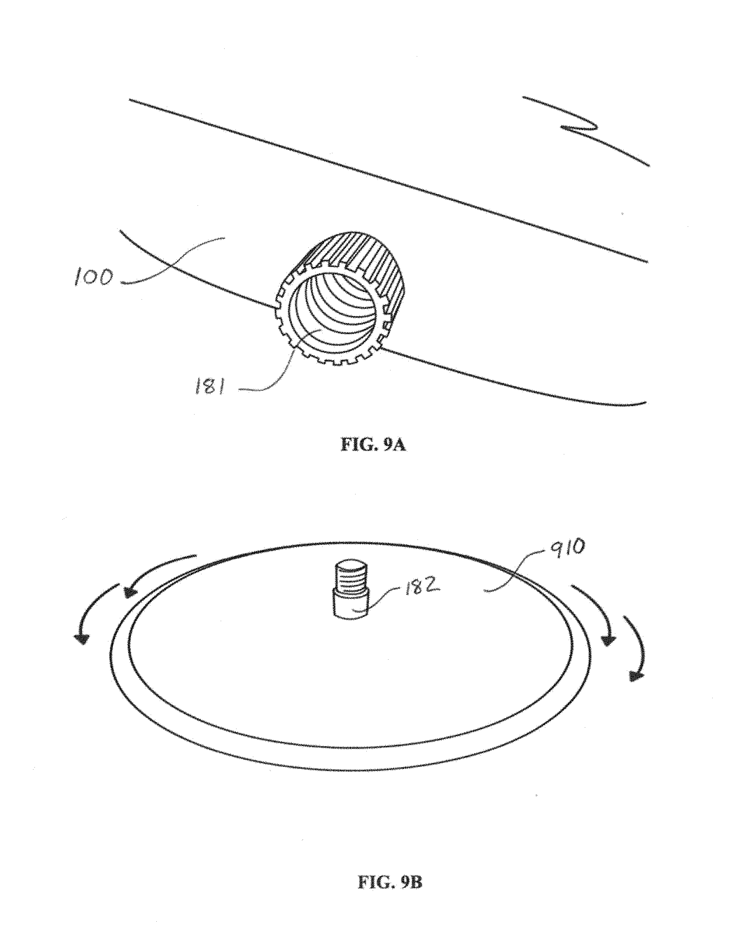

Referring to FIGS. 9A-9B, hardware for securing a form 100 to a base 910 is shown. The hardware includes a female screw fitting 181 integrated with the form 100 and a male screw shaft 182 integrated with a base 110/910. It should be appreciated that the association with base or form could be reversed without taking away form the teachings herein or the invention as claimed. To aid the baker/designer in handling the 3-D form, the form can include the female fitting 181 embedded just underneath, or at the bottom of, the 3-D body for the form 100. This female fitting can be attached by screwing the fitting into the male shaft fitting 182 that can be formed or welded onto a turntable base 910. Once the 3-D form is attached to the turntable base 910, the cupcakes can be taken out of the oven and immediately placed on the attachment means (e.g., spikes 120) on the form to cool or they may be added later after cooling. The fittings can be made of PVC, HDPE, metal, wood, nylon, plastic, hdpe, or any other material known in the art today.

In another embodiment, the base may be stationary and not have a male fitting to accept a female fitting. It may have a female fitting to accept a male fitting. In another embodiment, the base may have no fitting and the 3-D form may simply be placed atop the stationary base or the turntable base. The 3-D form may be taped to the stationary base, or the turntable base with double-sided tape, glue dots, caulking, hook and loop tape, hook and loop dots, hook and loop squares, or any other hook and loop affixing system available or used in the art today. It may be secured with frosting, or sticky melted sugar, or any other affixing system known in the art today. Certain designs of the 3-D system, such as the guitar design, may have a support rod running through the neck of the guitar. This rod may be made of plastic, wood, metal, PVC, HOPE, or any other material known in the art today. The rod may be an extension of the female fitting or it may be independent of the fitting if the 3-D form is of the type with no fitting embedded.

The turntable base 910 can also include a brake so that it will not continue to turn when pressure is put on the form when decorating the cupcakes. In another embodiment, the turntable base 910 can tilt or pivot in all directions or just forward and back, or just side to side.

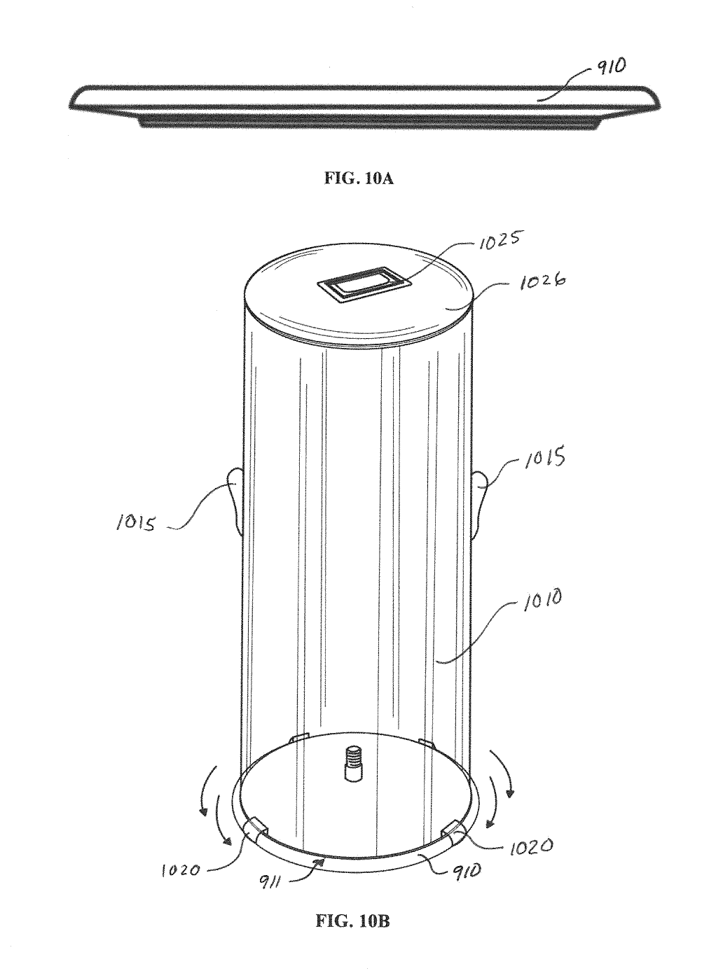

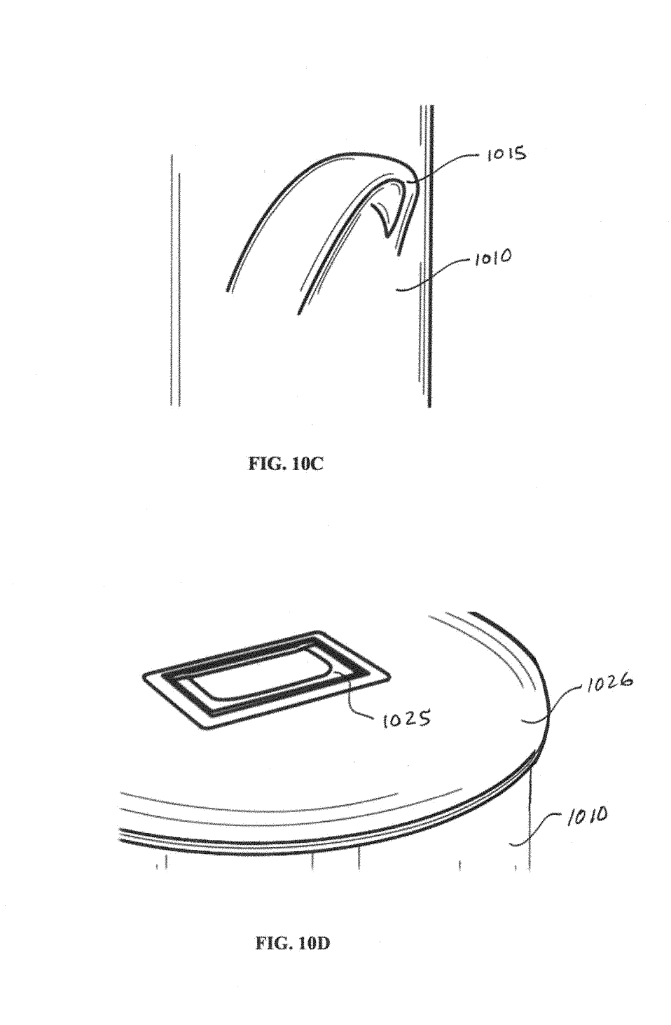

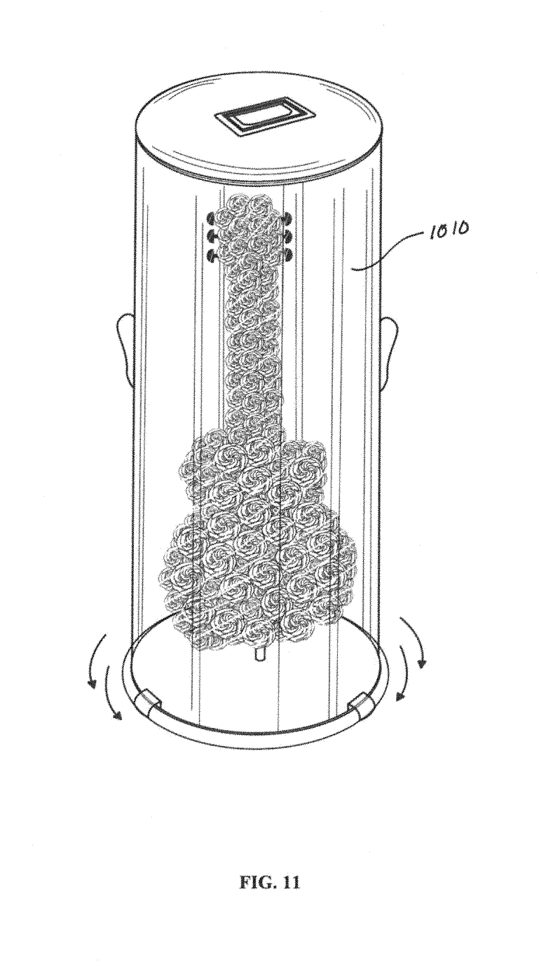

Referring to FIGS. 10A-10D, a turntable base 910 can have a groove 911 formed around its perimeter that accepts a cover 1010 that can fit on/along/within the groove 911. The cover 1010 can include handles 1015 located on the sides of the case 1010 for aiding the user in carrying the case and its contents (e.g., cupcakes in a 3-D design). The cover 1010 can be locked on to the turntable base 910 by a locking mechanism 1020 so that a carrying case and its contents are secured once the two pieces are locked together. The case 1010 can also include a handle 1025 at the top portion 1026 of the case 1010 to further facilitate movement and carrying of the case 1010. The top portion 1026 can be a rounded end-cap form that provides strength and integrity to the case. The case 1010 can be made of plastic, polyethylene, polystyrene, PVC, nylon, hdpe, or any other suitable material known in the art today. The locking mechanism 1020 does not have to be provided in the form of a latch, but can also be provided as any type of latch or locking system known in the art today. Referring to FIG. 11, illustrated is a cover 1010 as described herein with a fully decorated cupcake design on a form 100 attached to the base 910 as described herein. The cupcake design is secure and ready for safe transport within the case 1010.

In another embodiment, wheels may be attached underneath the turntable base, the base that does not turn, or to an additional holding tray that accepts the locking case atop. In another embodiment, a flat dolly with wheels may be used to carry extra large designs. The dolly may have a pulling handle comprised of a shaft attached at the base that may or may not be hinged and a handle at the tip of the shaft to hold the handle when pulling. The dolly base may or may not have a covering case that locks or latches.

For more efficient use of shelf space, the carrying case may be collapseable by use of accordion style design, hinged, as with a piano type hinge made of plastic metal or other suitable materials. The other side of the case will include an appropriate locking mechanism to keep the case together such as a snap lock or any other locking mechanism used in the art today. In another scenario, the two halves of the case could have opposing barrel fingers like a door hinge that fit together and are attached with a provided rod made of plastic, metal, nylon, acrylic, wood, or other suitable material known in the art today. This will allow the case to lie flat in a box when sold, or to be stored by the home baker. The entire unit can also be stored in its put together form based on what space is available to the baker.

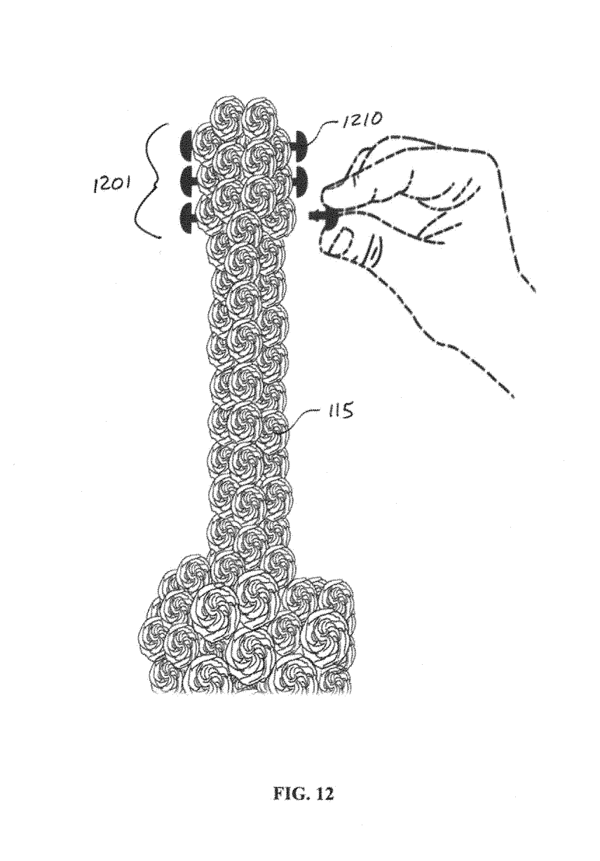

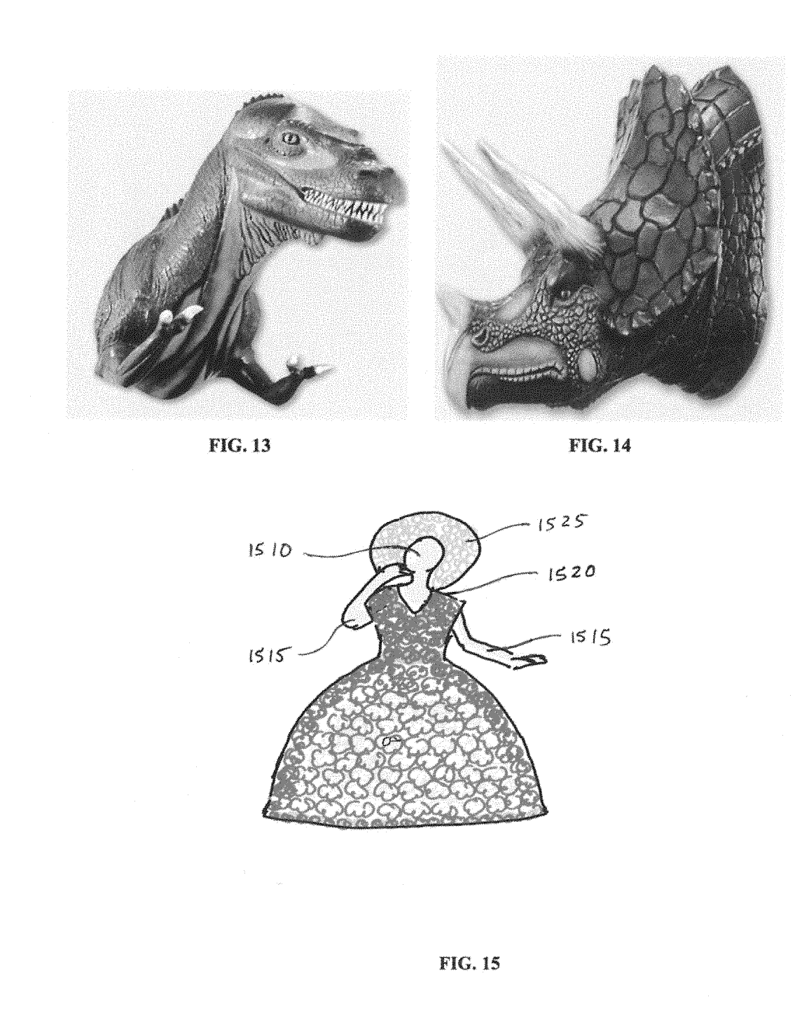

Further decorating elements may include detachable parts that are added to the form to add drama and fun to the design. For example, as shown in FIG. 12, guitar tuning keys 1210 can be inserted into the form 100 (also as shown in FIG. 1C) after cupcakes 115 have been placed on the form 100. Placement of detachable parts like this assist with the reality of the design or makes it more recognizable as the design it is proposed to be (e.g., a guitar in this case). These parts could be made of hard candy, chocolate, foam, plastic, nylon, pvc, rubber, nylon, wood, cardboard, paper Mache, or any other suitable material known in the art today. These parts could be pre-painted or the baker could paint them. They could come in simple detail or very realistic detail. Dinosaur heads, tails, feet, and claws are an example as are heads, tails, feet, and eyes of other animals. Purses, hats, high heels, jewelry, and other such accouterments may be added to forms for wedding designs, bridal shower designs, or any other design which the decorator chooses. Doll faces, arms, etc., may be added to forms to add detail to design. FIGS. 13-14 illustrates photographs of dinosaur heads and arms that can be inserted into a 3-D cupcake design by attaching these to the form 100. Then, as shown in FIG. 15, a plastic head 1510 and arms 1515 can be attached to a form 100 and a plurality of cupcakes 115 can be used to depict a dress 1520 and a hat 1525.

The 3-D forms can be, but are not limited to, shapes such as Dinosaurs, Elephants, Hippos, Mammoths, Zebras, Rhinos, Buffalo, Elk, Deer, Antelope, Turkeys, Ibex, Oryx, Zebras, Stags, Birds, Reptiles, Lions, Tigers, Bears, Ducks, Kangaroos, Cheetahs, Pumas, Jaguars, Giraffes, Monkeys, Gorillas, Orangutans, Horses, Cows, Pigs, Chickens, Peacocks, Grouse, Sloths, Bees, Sheep, Goats, Donkeys, Mules, Butterflies, Dragonflies, Spiders, Beetles, Ladybugs, Whales, Sharks, Dolphin, Fish, Porpoise, Octopus, Meerkats, Cats, Dogs, Unicorns, Mermaids, Dragons, Rivers, Oceans, Lakes, Guitars, Cellos, Flutes, Violins, Trombones, Drums, Musical Notes, Graduation Hats, Graduation Gowns, Baby Bottles, Baby Shoes, Baby Clothes Pacifiers, Eiffel Tower, Depiction of Mount Rushmore, Lincoln Memorial, Statue of Liberty, Flags, Numbers, Wedding Dresses, Wedding Veils, Wedding Shoes, Shoes, Purses, High Heels, Low Heels, Women's Clothes, Jewelry, Men's Clothes, Kids Clothes, Hats, Umbrellas, Flowers, Hearts Human Form, Parts of the Human Form, Animal Skulls, Human Skulls, Chairs, Beds, Windows, Houses, Doors, Planets, Cloud Shapes, Sun, Moon, Stars, Trees, Cars, Trucks, Trains, Covered Wagons, Construction Equipment, Earthmoving Equipment, Airplanes, Shovels, Motorcycles, Bikes, Scooters, Carts, Roller Skates, Skateboards, Spades, Rakes, Buckets, Dishes, Utensils, Bee Hives, Nests, Eggs, Faberge Eggs, Coins, Money, Buttons, Zippers, Scissors, Tools, Famous Art, Pies, Cakes, Cupcakes, Fruits, Vegetables, Desserts, Snowmen, Witches, Fairies, Christmas, Ornaments Wreaths, Bells, Whistles, Bags, Flower Pots, Spheres, Cubes, Geometric Shapes, Shapes of Countries, Universal Symbols, Tubs, Boxes, Fans, Stethoscopes, Doctors and Nurses Clothes and Hats, Medical devices, Badges, Gems, Gemstones, Suitcases, Trunks, Boats and Ships, Sea Craft, Lighthouses, Menorahs, Star of David, Crosses, Statues, Kali, Buddha, Gods of all Religions, Jesus, God, Madonna, Clocks, Candles, Books, Bible, Bird Houses, Barns, Churches, Praying Hands, Books, Rosary Beads, Crosses, Religious symbols, Chalices, Electronic Devices, Blocks, Megaphones, Cards, Dice, Board Games, Jacks and Balls, Comets, Wood, Towers, Igloos, Teepees, Christmas Trees, Vampires, Werewolves, Tree Houses, Exercise Equipment, Volcanos, Geodes, Mountains, Rocks, Dog Houses, Stuffed Toys, Toys, Bubbles, Balloons, Hot Air Balloons, Blimps, Covered Wagons, Rockets, Submarines, Depictions of cartoons or figures from animated movies, Dolls, Action Figures, Super Heroes, Puppets, Marionettes, Punctuation Marks, or any other object known in the art today.

Based on the foregoing, it can be appreciated that a number of embodiments, preferred and alternative, are disclosed herein. It will be appreciated that variations of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A 3-D cupcake decorating system, comprising: a form including attachment means for securing a plurality of cupcakes about the form and a base supporting the form in an upright position.

2. The system of claim 1, wherein the attachment means comprises at least one of spikes, collars, cups, double-sided tape, glue dots, bamboo skewers, and toothpicks.

3. The system of claim 1, wherein the attachment means comprises a plurality of spikes mounted to the form in a manner wherein cupcakes can be pushed onto and secured by the spikes against the form.

4. The system of claim 1, wherein the attachment means comprises a plurality of spikes mounted to the form in a manner and wherein the plurality of spikes are mounted to the form in a manner whereby the plurality of spikes are slanted upwards so the cupcakes can be pushed onto and secured by the upwards-slanted spikes and rest securely against the form.

5. The system of claim 3, wherein the form is attachable to the base.

6. The system of claim 1, wherein the form is provided in the general shape of at least one of: Dinosaurs, Elephants, Hippos, Mammoths, Zebras, Rhinos, Buffalo, Elk, Deer, Antelope, Turkeys, Ibex, Oryx, Zebras, Stags, Birds, Reptiles, Lions, Tigers, Bears, Ducks, Kangaroos, Cheetahs, Pumas, Jaguars, Giraffes, Monkeys, Gorillas, Orangutans, Horses, Cows, Pigs, Chickens, Peacocks, Grouse, Sloths, Bees, Sheep, Goats, Donkeys, Mules, Horses, Butterflies, Dragonflies, Spiders, Beetles, Ladybugs, Spiders, Whales, Sharks, Dolphin, Fish, Porpoise, Octopus, Meerkats, Cats, Dogs, Unicorns, Mermaids, Dragons, Rivers, Oceans, Lakes, Guitars, Cellos, Flutes, Violins, Trombones, Drums, Musical Notes, Graduation Hats, Graduation Gowns, Baby Bottles, Baby Shoes, Baby Clothes, Pacifiers, Eiffel Tower, Depiction of Mount Rushmore, Lincoln Memorial, Statue of Liberty, Flags, Numbers, Wedding Dresses, Wedding Veils, Wedding Shoes, Shoes, Purses, High Heels, Low Heels, Women's Clothes, Jewelry, Men's Clothes, Kids Clothes, Hats, Umbrellas, Flowers, Hearts, Human Form, Parts of the Human Form, Animal Skulls, Human Skulls, Chairs, Beds, Windows, Houses, Doors, Planets, Cloud Shapes, Sun, Moon, Stars, Trees, Cars, Trucks, Trains, Covered Wagons, Construction Equipment, Earthmoving Equipment, Airplanes, Shovels, Motorcycles, Bikes, Scooters, Carts, Roller Skates, Skateboards, Spades, Rakes, Buckets, Dishes, Utensils, Bee Hives, Nests, Eggs, Faberge Eggs, Coins, Money, Buttons, Zippers, Scissors, Tools, Famous Art, Pies, Cakes, Cupcakes, Fruits, Vegetables, Desserts, Snowmen, Witches, Fairies, Christmas, Ornaments Wreaths, Bells, Whistles, Bags, Flower Pots, Spheres, Cubes, Geometric Shapes, Shapes of Countries, Universal Symbols, Tubs, Boxes, Fans, Stethoscopes, Doctors and Nurses Clothes and Hats, Medical devices, Badges, Gems, Gemstones, Suitcases, Trunks, Boats and Ships, Sea Craft, Lighthouses, Menorahs, Star of David, Crosses, Statues, Kali, Buddha, Gods of all Religions, Jesus, God, Madonna, Clocks, Candles, Books, Bible, Bird Houses, Barns, Churches, Praying Hands, Books, Rosary Beads, Crosses, Religious symbols, Chalices, Electronic Devices, Blocks, Megaphones, Cards, Dice, Board Games, Jacks and Balls, Comets, Wood, Towers, Igloos, Teepees, Christmas Trees, Hearts, Vampires, Werewolves, Tree Houses, Exercise Equipment, Volcanos, Geodes, Mountains, Rocks, Dog Houses, Stuffed Toys, Toys, Bubbles, Balloons, Hot Air Balloons, Blimps, Covered Wagons, Rockets, Submarines, Depictions of cartoons or figures from animated movies, Dolls, Action Figures, Super Heroes, Puppets, Marionettes, and Punctuation Marks.

7. The system of claim 1, further comprising a carrying case including handles and a top, wherein the cover is attachable to the base via a locking mechanism and wherein the carrying case completely covers and secures the form and cupcakes assembled within the case and supported by the base.

8. The system of claim 1, further comprising filler plugs adapted to accept decorative material in the form of at least one of cake frosting, stickers, candy pieces, coins, flowers, plastic objects, wherein the decorative material is attached to the form to fill spaces between cupcakes held on the form.

9. A three-dimensional cupcake decorating system, comprising:
a form;
a plurality of spikes mounted on the form for securing a plurality of cupcakes about the form; and
a base supporting the form in an upright position.

10. The system of claim 9, wherein the plurality of spikes are mounted to the form in a manner wherein cupcakes can be pushed onto and secured by the spikes against the form.

11. The system of claim 10, wherein the plurality of spikes are mounted to the form in a manner whereby the plurality of spikes are slanted upwards so the cupcakes can be pushed onto and secured by the upwards-slanted spikes and rest securely against the form.

12. The system of claim 9, further comprising a carrying case including handles and a top, wherein the cover is attachable to the base via a locking mechanism and wherein the carrying case completely covers and secures the form and cupcakes assembled within the case and supported by the base.

13. The system of claim 9, further comprising filler plugs adapted to accept decorative material in the form of at least one of cake frosting, stickers, candy pieces, coins, flowers, plastic objects, wherein the decorative material is attached to the form to fill spaces between cupcakes held on the form.

14. The system of claim 9, wherein the form is provided in the general shape of at least one of: Dinosaurs, Elephants, Hippos, Mammoths, Zebras, Rhinos, Buffalo, Elk, Deer, Antelope, Turkeys, Ibex, Oryx, Zebras, Stags, Birds, Reptiles, Lions, Tigers, Bears, Ducks, Kangaroos, Cheetahs, Pumas, Jaguars, Giraffes, Monkeys, Gorillas, Orangutans, Horses, Cows, Pigs, Chickens, Peacocks, Grouse, Sloths, Bees, Sheep, Goats, Donkeys, Mules, Horses, Butterflies, Dragonflies, Spiders, Beetles, Ladybugs, Whales, Sharks, Dolphin, Fish, Porpoise, Octopus, Meerkats, Cats, Dogs, Unicorns, Mermaids, Dragons, Rivers, Oceans, Lakes, Guitars, Cellos, Flutes, Violins, Trombones, Drums, Musical Notes, Graduation Hats, Graduation Gowns, Baby Bottles, Baby Shoes, Baby Clothes, Pacifiers, Eiffel Tower, Depiction of Mount Rushmore, Lincoln Memorial, Statue of Liberty, Flags, Numbers, Wedding Dresses, Wedding Veils, Wedding Shoes, Shoes, Purses, High Heels, Low Heels, Women's Clothes, Jewelry, Men's Clothes, Kids Clothes, Hats, Umbrellas, Flowers, Hearts, Human Form, Parts of the Human Form, Animal Skulls, Human Skulls, Chairs, Beds, Windows, Houses, Doors, Planets, Cloud Shapes, Sun, Moon, Stars, Trees, Cars, Trucks, Trains, Covered Wagons, Construction Equipment, Earthmoving Equipment, Airplanes, Shovels, Motorcycles, Bikes, Scooters, Carts, Roller Skates, Skateboards, Spades, Rakes, Buckets, Dishes, Utensils, Bee Hives, Nests, Eggs, Faberge Eggs, Coins, Money, Buttons, Zippers, Scissors, Tools, Famous Art, Pies, Cakes, Cupcakes, Fruits, Vegetables, Desserts, Snowmen, Witches, Fairies, Christmas, Ornaments Wreaths, Bells, Whistles, Bags, Flower Pots, Spheres, Cubes, Geometric Shapes, Shapes of Countries, Universal Symbols, Tubs, Boxes, Fans, Stethoscopes, Doctors and Nurses Clothes and Hats, Medical devices, Badges, Gems, Gemstones, Suitcases, Trunks, Boats and Ships, Sea Craft, Lighthouses, Menorahs, Star of David, Crosses, Statues, Kali, Buddha, Gods of all Religions, Jesus, God, Madonna, Clocks, Candles, Books, Bible, Bird Houses, Barns, Churches, Praying Hands, Books, Rosary Beads, Crosses, Religious symbols, Chalices, Electronic Devices, Blocks, Megaphones, Cards, Dice, Board Games, Jacks and Balls, Comets, Wood, Towers, Igloos, Teepees, Christmas Trees, Hearts, Vampires, Werewolves, Tree Houses, Exercise Equipment, Volcanos, Geodes, Mountains, Rocks, Dog Houses, Stuffed Toys, Toys, Bubbles, Balloons, Hot Air Balloons, Blimps, Covered Wagons, Rockets, Submarines, Depictions of cartoons or figures from animated movies, Dolls, Action Figures, Super Heroes, Puppets, Marionettes, and Punctuation Marks.

15. A method for creating a three-dimensional cupcake decoration in the analogous form of topiary, comprising:
providing a form in the shape of a three-dimensional figure, wherein the form is mounted onto and supported by a base in an upright position and includes a plurality of spikes mounted on the form for securing a plurality of cupcakes about the form;
pushing basked cupcakes onto the spikes whereon the cupcakes are secured by the spikes against the form thereby further creating a three-dimensional figure;
placing icing on the cupcakes being supported by the form in an upright position; and
inserting plugs within spaces between cupcakes supported by the form.

16. The method of claim 15, wherein the three-dimensional figure of the form is provided in the general shape of at least one of: Dinosaurs, Elephants, Hippos, Mammoths, Zebras, Rhinos, Buffalo, Elk, Deer, Antelope, Turkeys, Ibex, Oryx, Zebras, Stags, Birds, Reptiles, Lions, Tigers, Bears, Ducks, Kangaroos, Cheetahs, Pumas, Jaguars, Giraffes, Monkeys, Gorillas, Orangutans, Horses, Cows, Pigs, Chickens, Peacocks, Grouse, Sloths, Bees, Sheep, Goats, Donkeys, Mules, Horses, Butterflies, Dragonflies, Spiders, Beetles, Ladybugs, Whales, Sharks, Dolphin, Fish, Porpoise, Octopus, Meer Cat, Cats, Dogs, Unicorns, Mermaids, Dragons, Rivers, Oceans, Lakes, Guitars, Cellos, Flutes, Violins, Trombones, Drums, Musical Notes, Graduation Hats, Graduation Gowns, Baby Bottles, Baby Shoes, Baby Clothes, Pacifiers, Eiffel Tower, Depiction of Mount Rushmore, Lincoln Memorial, Statue of Liberty, Flags, Numbers, Wedding Dresses, Wedding Veils, Wedding Shoes, Shoes, Purses, High Heels, Low Heels, Women's Clothes, Jewelry, Men's Clothes, Kids Clothes, Hats, Umbrellas, Flowers, Hearts, Human Form, Parts of the Human Form, Animal Skulls, Human Skulls, Chairs, Beds, Windows, Houses, Doors, Planets, Cloud Shapes, Sun, Moon, Stars, Trees, Cars, Trucks, Trains, Covered Wagons, Construction Equipment, Earthmoving Equipment, Airplanes, Shovels, Motor Cycles, Bike's, Scooters, Carts, Roller Skates, Skateboards, Spades, Rakes, Buckets, Dishes, Utensils, Bee Hives, Nests, Eggs, Faberge Eggs, Coins, Money, Buttons, Zippers, Scissors, Tools, Famous Art, Pies, Cakes, Cupcakes, Fruits, Vegetables, Desserts, Snowmen, Witches, Fairies, Christmas, Ornaments Wreaths, Bells, Whistles, Bags, Flower Pots, Spheres, Cubes, Geometric Shapes, Shapes of Countries, Universal Symbols, Tubs, Boxes, Fans, Stethoscopes, Doctors and Nurses Clothes and Hats, Medical devices, Badges, Gems, Gemstones, Suitcases, Trunks, Boats and Ships, Sea Craft, Lighthouses, Menorahs, Star of David, Crosses, Statues, Kali, Buddha, Gods of all Religions, Jesus, God, Madonna, Clocks, Candles, Books, Bible, Bird Houses, Barns, Churches, Praying Hands, Books, Rosary Beads, Crosses, Religious symbols, Chalices, Electronic Devices, Blocks, Megaphone's, Cards, Dice, Board Games, Jacks and Balls, Comets, Wood, Towers, Igloos, Teepees, Christmas Trees, Hearts, Vampires, Werewolves, Tree Houses, Exercise Equipment, Volcano's, Geodes, Mountains, Rocks, Dog Houses, Stuffed Toys, Toys, Bubbles, Balloons, Hot Air Balloons, Blimps, Covered Wagons, Rockets, Submarines, Depictions of cartoons or figures from animated movies, Dolls, Action Figures, Super Heroes, Puppets, Marionettes, and Punctuation Marks.

17. The method of claim 15, further comprising placing a carrying case including handles and a top over the three-dimensional figure including cupcakes with icing thereon, and attaching the cover to the base via a locking mechanism supplied with the carrying case, wherein the carrying case completely covers and secures the form and cupcakes assembled within the case and supported by the base.
